(19) United States
(12) Patent Application Publication
(10) Pub. No.: US 2023/0266491 A1
(43) Pub. Date: Aug. 24, 2023

(54) METHOD AND SYSTEM FOR PREDICTING HYDROCARBON RESERVOIR INFORMATION FROM RAW SEISMIC DATA

(71) Applicant: SAUDI ARABIAN OIL COMPANY, Dhahran (SA)

(72) Inventors: Saleh Al-Saleh, Dhahran (SA); Jianwu Jiao, Dhahran (SA); Ewenet Gashawbeza, Dhahran (SA); Husain Shakhs, Dhahran (SA)

(73) Assignee: SAUDI ARABIAN OIL COMPANY, Dhahran (SA)

(21) Appl. No.: 17/651,682

(22) Filed: Feb. 18, 2022

(51) Int. Cl. G01V 1/28; G01V 1/30

(52) U.S. Cl. CPC G01V 1/282; G01V 1/301; G01V 2210/66; G01V 2210/673; G01V 2210/64; G01V 2210/6169; G01V 2210/614

(57) ABSTRACT

Systems and methods of identifying a drilling target are disclosed. The method includes obtaining a training set of base subsurface models and generating, using a first artificial intelligence neural network, a plurality of subsurface model realizations based on the base subsurface models. The method further includes simulating, for each subsurface model realization, a synthetic seismic dataset and training a second artificial intelligence neural network, using the plurality of subsurface model realizations and the corresponding synthetic seismic dataset for each subsurface model realization, to predict an inferred subsurface model from a seismic dataset. The method still further includes obtaining an observed seismic dataset for a subterranean region of interest, predicting, using the trained second artificial intelligence neural network, an inferred subsurface model from the observed seismic dataset, and identifying the drilling target based on the inferred subsurface model.

### BACKGROUND

In the oil and gas industry, a variety of geophysical techniques have been developed to construct images of the subsurface. Principal among them is seismic data processing, which offers high resolution images over a large volume of space in the subsurface. Traditional seismic techniques used by geophysicists are computer memory and computation intensive and are usually broken into two steps—the first estimates a large-scale background velocity model of the subsurface, the second uses the velocity structure to spatially delineate smaller-scale reflective bodies. The produced seismic image may be used to locate and drill for hydrocarbon targets.

In contrast to the quantitative work of geophysicists, geologists possess a wealth of qualitative information as to the expected shape and distribution of different geological patterns encountered in hydrocarbon reservoirs. This information should help constrain and guide the construction of an image of the subsurface, but it is difficult to insert this information into the seismic processing workflow and it is usually added in a manual, time-consuming, and ad-hoc fashion.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments related to a method of identifying a drilling target are disclosed. The method includes obtaining a training set of base subsurface models and generating, using a first artificial intelligence neural network, a plurality of subsurface model realizations based on the base subsurface models. The method further includes simulating, for each subsurface model realization, a synthetic seismic dataset and training a second artificial intelligence neural network, using the plurality of subsurface model realizations and the corresponding synthetic seismic dataset for each subsurface model realization, to predict an inferred subsurface model from a seismic dataset. The method still further includes obtaining an observed seismic dataset for a subterranean region of interest, predicting, using the trained second artificial intelligence neural network, an inferred subsurface model from the observed seismic dataset, and identifying the drilling target based on the inferred subsurface model.

In general, in one aspect, embodiments relate to a non-transitory computer readable medium storing instructions executable by a computer processor with functionality for identifying a drilling target. The instructions include functionality for receiving a training set of base subsurface models and generating, using a first artificial intelligence neural network, a plurality of subsurface model realizations based on the base subsurface models. The instructions further include functionality for simulating, for each subsurface model realization, a synthetic seismic dataset and training a second artificial intelligence neural network, using the plurality of subsurface model realizations and the corresponding synthetic seismic dataset for each subsurface model realization, to predict an inferred subsurface model from a seismic dataset. The instructions still further include functionality for obtaining an observed seismic dataset for a subterranean region of interest, predicting, using the trained second artificial intelligence neural network, an inferred subsurface model from the observed seismic dataset, and identifying the drilling target based on the inferred subsurface model.

In general, in one aspect, embodiments relate to a system, including a memory and a computer processor, configured to identify a drilling target and determine a wellbore path are disclosed. The computer processor is configured to obtain a training set of base subsurface models and generate, using a first artificial intelligence neural network, a plurality of subsurface model realizations based on the base subsurface models. The computer processor is further configured to simulate, for each subsurface model realization, a synthetic seismic dataset and train a second artificial intelligence neural network, using the plurality of subsurface model realizations and the corresponding synthetic seismic dataset for each subsurface model realization, to predict an inferred subsurface model from a seismic dataset. The computer processor is still further configured to obtain an observed seismic dataset for a subterranean region of interest, predict, using the trained second artificial intelligence neural network, an inferred subsurface model from the observed seismic dataset, identify the drilling target based on the inferred subsurface model, and determine a wellbore path to intersect the drilling target.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows seismic survey equipment in accordance with one or more embodiments.

FIG. 2 shows a portion of a simulated seismic dataset in accordance with one or more embodiments.

FIG. 3 shows a subsurface model in accordance with one or more embodiments.

FIG. 4 shows a visual representation of a GANN and DNN in accordance with one or more embodiments.

FIG. 5 shows a flowchart in accordance with one or more embodiments.

FIG. 6 shows inferred subsurface models in accordance with one or more embodiments.

FIG. 7 shows a drilling system in accordance with one or more embodiments.

FIG. 8 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

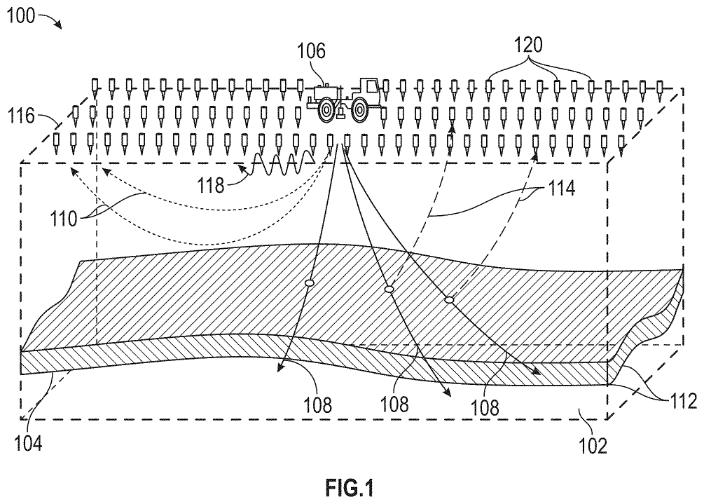

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic dataset” includes reference to one or more of such seismic datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments are described for targeting wells to be drilled into hydrocarbon reservoirs. A large number of subsurface training models containing complex geological forms may be generated by applying a first artificial intelligence [AI] technique to a small set of base subsurface models that exhibit the similar complex geological forms found or expected in the subsurface. Simulating synthetic seismic data from the subsurface training models provides another second training set to which a second AI technique may be trained to predicting an inferred subsurface model from an observed seismic dataset. These embodiments allow geological knowledge of the subsurface to be determined directly from seismic data. Wells may be targeted based on the resulting geological knowledge of the subsurface.

The term “seismic data” as used herein broadly means any data received and/or recorded as part of the seismic surveying process, including particle displacement, velocity and/or acceleration, pressure and/or rotation, wave reflection, and/or refraction data. “Seismic data” is also intended to include any data (e.g., seismic image, migration image, reverse-time migration image, pre-stack image, partially-stack image, full-stack image, post-stack image or seismic attribute image) or properties, including geophysical properties such as one or more of: elastic properties (e.g., P and/or S wave velocity, P-Impedance, S-Impedance, density, attenuation, anisotropy and the like); and porosity, permeability or the like, that the ordinarily skilled artisan at the time of this disclosure will recognize may be inferred or otherwise derived from such data received and/or recorded as part of the seismic surveying process. Thus, this disclosure may at times refer to “seismic data and/or data derived therefrom,” or equivalently simply to “seismic data.” Both terms are intended to include both measured/observed seismic data and such derived data, unless the context clearly indicates that only one or the other is intended. “Seismic data” may also include data derived from traditional seismic (i.e., acoustic) datasets in conjunction with other geophysical data, including, for example, gravity plus seismic; gravity plus electromagnetic plus seismic data, etc. For example, joint inversion utilizes multiple geophysical data types.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region may be conceptually divided into discrete cells for computational purposes. For example, the spatial distribution of velocity may be modeled using constant-velocity units (layers) through which ray paths obeying Snell's law can be traced. A 3-D geologic model (particularly a model represented in image form) may be represented in volume elements (voxels), in a similar way that a photograph (or 2-D geologic model) is represented by picture elements (pixels). Such numerical representations may be shape-based or functional forms in addition to, or in lieu of, cell-based numerical representations.

Subsurface model is a model (or map) associated with numerical, ordinal, or categorical parameters that represent properties of the subsurface (e.g., geological, geophysical, petrophysical, reservoir, stratigraphic, or statistical properties).

Geophysical model is a model associated the geo-physical properties of the subsurface (e.g., wave speed or velocity, density, attenuation, anisotropy).

Petrophysical model is a model associated the petrophysical properties of the subsurface (e.g., saturation, porosity, permeability, transmissibility, tortuosity).

Geophysical data is the data probing the geophysical properties of the subsurface (e.g., seismic, electromagnetic, gravity).

Geological model is a spatial representation of the distribution of sediments and rocks (rock types) in the subsurface.

Reservoir model is a model describing the fluid storage and flow characteristics of the reservoir.

Stratigraphic model is a spatial representation of the sequences of sediment and rocks (rock types) in the subsurface.

Reservoir (structural) framework is the structural analysis of reservoir based on the interpretation of 2D or 3D seismic images. For examples, reservoir framework comprises horizons, faults and surfaces inferred from seismic at a reservoir section.

FIG. 1 shows a seismic survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of land. The seismic survey (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface of the earth (116) as refracted seismic waves (110) or may be reflected by geological discontinuities (112) and return to the surface as reflected seismic waves (114). The radiated seismic waves may propagate along the surface as Rayleigh waves or Love waves, collectively known as “ground-roll” (118). Vibrations associated with ground-roll (118) do not penetrate far beneath the surface of the earth (116) and hence are not influenced, nor contain information about, portions of the subterranean region of interest (102) where hydrocarbon reservoirs (104) are typically located. Seismic receivers (120) located on or near the surface of the earth (116) detect reflected seismic waves (114), refracted seismic waves (110) and ground-roll (118).

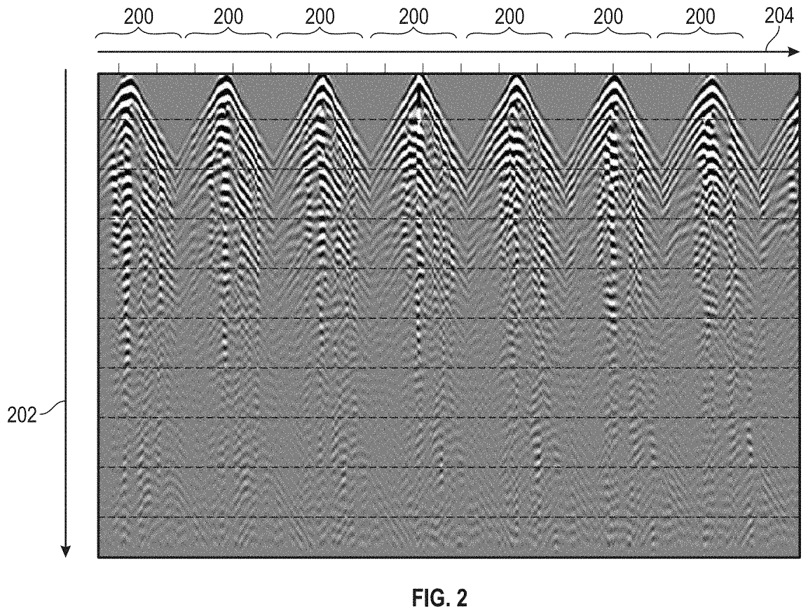

FIG. 2 is an embodiment of a series of seismic shot gathers (200). Each panel represents a seismic data collection experiment where a source (106) is fired and the refracted seismic waves (110), reflected seismic waves (114), and ground roll seismic waves (118) are recorded at seismic receivers (120). Each seismic shot gather (200) is the recording of the firing or firings of a seismic source (106) at a single source location recorded at a range of seismic source to seismic receiver (120) separations or “offsets”. The amplitudes of the recorded seismic waves are displayed on a grayscale (not shown) with the recording time indicated on the vertical axis (202) and the surface location indicated on the horizontal axis (204). When obtained through simulation, the characteristics of simulated seismic shot gathers (200) are affected by the features of the subsurface model used in the simulation including the background model and the distribution of geological bodies. The characteristics of a recorded, or observed, seismic shot gather is affected by the geological structure of the subterranean region below the seismic survey (100).

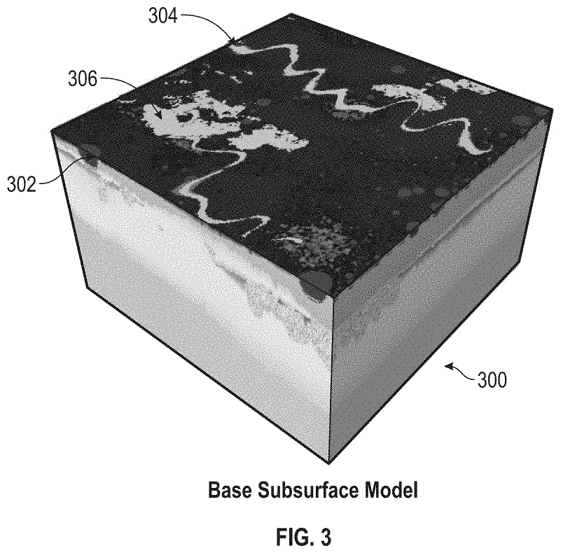

FIG. 3 shows a base subsurface model (300), a member of the GANN training set, in accordance with one or more embodiments. The base subsurface model (300) may be a realistic model containing multiple geological bodies including sedimentary features such as Karsts (i.e., water-eroded limestone) (302), sand dunes (306), ancient riverbeds (304), and other facies. A GANN training dataset will include a plurality of base subsurface models. The specific types and characteristics of the geological bodies present in the GANN training set may be determined based upon a specific region, such as a sedimentary basin or hydrocarbon field, of interest.

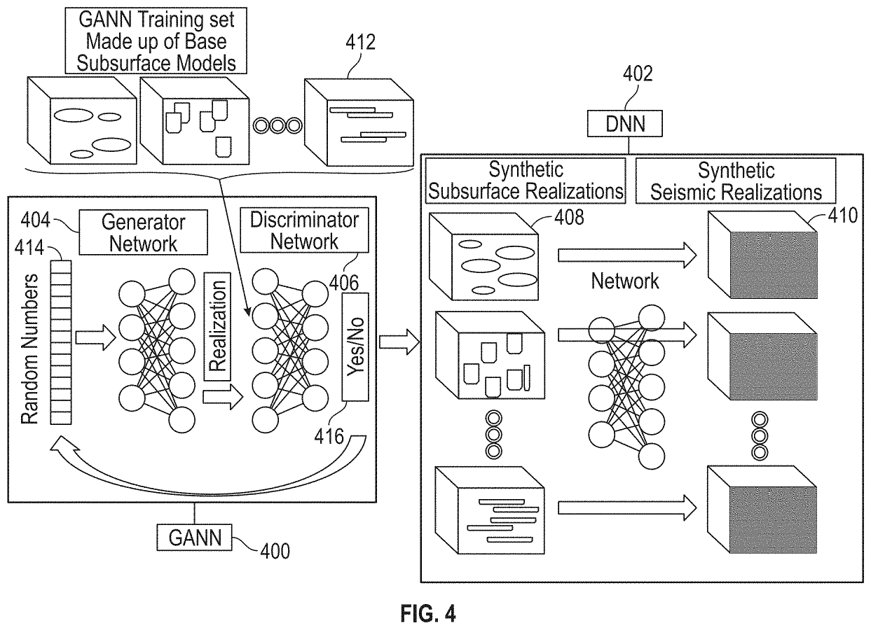

FIG. 4 presents embodiments of different neural networks: a Generative Adversarial Neural Network [GANN] (400) (which itself contains two networks) and a Deep Neural Network [DNN] (402). The GANN (400) may require as input multiple subsurface base models (412). The base models may be created using digital drawing tool or using other software packages. For example, the base models may have been created using digital image recognition software applied to seismic images of adjacent surface regions. The GANN (400) then runs both a generator neural network (404) (i.e., generator) and a discriminator neural network (406) (i.e., discriminator) iteratively or recursively until the synthetic subsurface models produced by the generator are statistically indistinguishable from the base models in the GANN training set (412). The generator may now be used to quickly create realistic synthetic subsurface models (408). Each synthetic subsurface model (408) output from the generator (404) is used to simulate a synthetic seismic dataset (410). The plurality of pairs of one synthetic subsurface model output from the GANN (408) and its corresponding synthetic seismic dataset (410) constitute the DNN training set and is used to train the DNN (402). Once the DNN (402) is trained, the trained model is used to predict an inferred subsurface model e.g., a geological model (602) or velocity model (604)) from synthetic or observed seismic data.

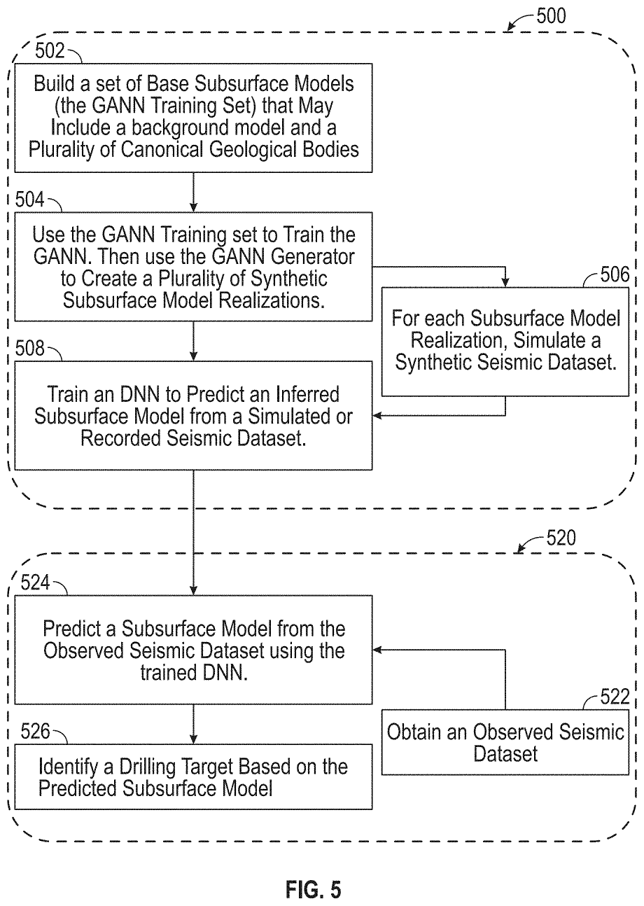

FIG. 5 shows a flowchart in accordance with one or more embodiments. The first group of steps (500) delineates the training of the DNN (402) using a GANN (400) to generate training models as illustrated in FIG. 4. The second group of steps (520) describes the application of the trained DNN to an observed seismic dataset (200) to predict an inferred model of the subsurface (524). In addition, the second group of steps (520) describes the use of the resulting subsurface model to identify a drilling target (526) and plan a wellbore path to intersect the predicted target.

Initially, as part of the first group (500), in Step 502, a set of base subsurface models of the GANN training set is built in accordance with one or more embodiments. The base subsurface models of the GANN training set may include a background model, that may be a homogeneous or smoothly varying model, and a plurality of canonical geological bodies. The canonical geological bodies may be chosen, without limitation, from limestone caves or “karsts” (302), buried or exposed river channels or “wadis” (304), and buried sand dunes (306).

In Step 504, a plurality of subsurface model realizations is generated based on the base subsurface models of the GANN training set. Each subsurface model realization may include a description of the seismic compressional wave velocity, the seismic shear wave velocity, and the density as a function of position within the subsurface. In addition, each subsurface model may include a description of the seismic compressional wave attenuation and the seismic shear wave attenuation as a function of position within the subsurface. The plurality of subsurface model realizations may be generated using an artificial intelligence (AI) neural network that may be a GANN.

A GANN itself comprises two separate networks, the first is a generator (404) that sends random number input (414) through a mathematical transformation network to produce an output that hopefully resembles elements of a training dataset. The second network in the GANN is a discriminator (406)—a nonlinear mathematical transformation network that takes the realizations produced by the generator and reduces them to a yes/no answer (416). ‘Yes’ means that the output is viewed as indistinguishable from the elements of the GANN training dataset. ‘No’ means that the realization of the generator does not look like an element of the GANN training data. The GANN is run many times; at each iteration, the results of the discriminator lead to changes in weights of both the generator and discriminator networks until a situation is reached such that the discriminator rejects models proposed by the generator with a 50% probability. This is equivalent to saying that models created by the generator and the models in the GANN training set are indistinguishable from each other. Put another way, a 50% rejection rate is optimal when trying to distinguish the output of two identical generation mechanisms (in this case, the GANN generator and the GANN training set). Once this limiting rate is reached, the generator can be taken out of the GANN and used solely to create new synthetic subsurface models.

In Step 506, in accordance with one or more embodiments, a simulated seismic dataset (410) is generated for each member of the plurality of subsurface model realizations output by the GANN generator (404). The simulated seismic dataset may be based upon the seismic compressional wave velocity and attenuation, the shear wave velocity and attenuation, and the density specified by the subsurface model realization and upon a predetermined distribution of seismic sources (106) and seismic receivers (120). The synthetic seismic dataset may be generated using a time-domain finite-difference modeling algorithm, a frequency-domain finite-difference modeling algorithm, a time-domain finite-element modeling algorithm, or a frequency-domain finite element modeling algorithm, or using any other seismic modeling algorithm familiar to a person of ordinary skill in the art without departing from the scope of the invention.

In Step 508, an AI neural network is trained to predict an inferred subsurface model from a synthetic or observed seismic dataset. In one or more embodiments, the AI neural network may be a DNN. Specifically, the AI neural network may be trained using DNN training set consisting of each of the plurality of subsurface model realizations and the corresponding synthetic seismic dataset simulated for each subsurface model realization. In accordance with some embodiments, the inferred subsurface model may be parameterized in terms of seismic compressional and shear velocities, seismic compressional and shear attenuations and density. In accordance with other embodiments, the inferred subsurface model may be parameterized in terms of a background model and a collection of canonical geological bodies.

In accordance with some embodiments, steps (504), (506), and (508) may be carried out sequentially, i.e., all the of the plurality of the subsurface model realizations may be generated first, then the synthetic seismic dataset simulated for each subsurface model realizations may be generated second, and finally the AI neural network may be trained. In accordance with other embodiments, steps (504), (506) and (508) may be carried out in parallel. For example, one or a subset of the plurality of subsurface model realizations may be generated, followed by the simulation of the corresponding synthetic seismic datasets, followed by an initial training of the AI neural network. Then a second, or a second subset of the plurality of subsurface model realizations may be generated, followed by the simulation of the additional corresponding synthetic seismic datasets, followed by an updating or re-training of the AI neural network. This subsurface model realization, seismic simulation, and updating of the AI neural network may continue until a predetermined ending point or criterion is reached.

In accordance with one or more embodiments, the trained AI neural network is applied in the second group of steps (520) to an observed seismic dataset obtained in Step (522).

In Step 524, an inferred subsurface model is predicted from synthetic or observed seismic dataset using the trained AI neural network. The inferred subsurface model may be parameterized in terms of seismic compressional and shear velocities, seismic compressional and shear attenuations and density or in terms of a background model and a collection of canonical geological bodies.

In Step 526 a drilling target is identified based, at least in part, on the inferred subsurface model. For example, the drilling target may be region of anomalously high or low seismic velocity or attenuation or a region of anomalously high or low density compared to the regions surrounding it. Further, a wellbore path from a surface location, or from a point within a pre-existing well, may be determined to reach the identified drilling target and a well may be drilled based upon the wellbore path through which to produce hydrocarbons.

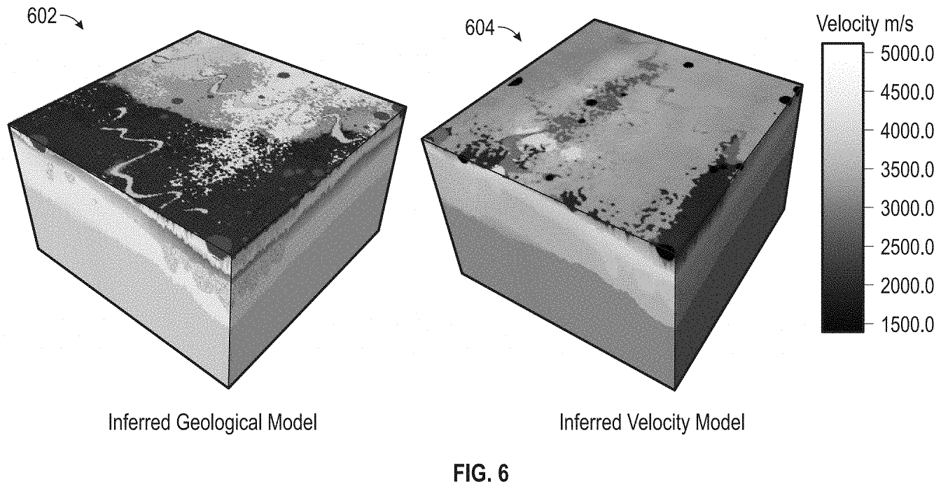

FIG. 6 depicts an example of the inferred subsurface model produced by the DNN (402) from an input observed seismic dataset (200). The output subsurface model may be a facies model (602) or a velocity model (604) that exhibits geologically realistic patterns such as Karsts (302), wadis (304), and sand dunes (306).

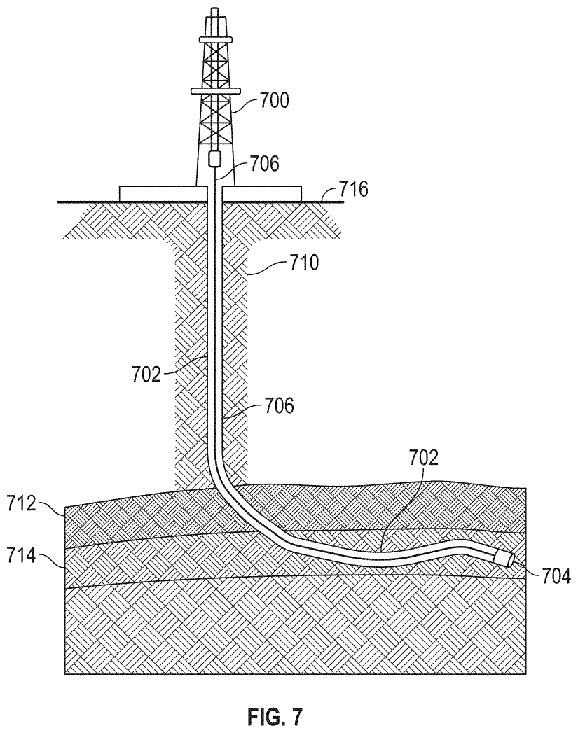

FIG. 7 illustrates systems in accordance with one or more embodiments. Specifically, FIG. 7 shows an application of the processes discussed above in FIGS. 4-6. As shown in FIG. 7, a well (702) may be drilled by a drill bit (704) attached by a drillstring (706) to a drill rig (700) located on the surface of the earth (116). The well may traverse a plurality of overburden layers (710) and one or more cap-rock layers (712) to a hydrocarbon reservoir (714). In accordance with one or more embodiments, the updated seismic velocity model (604), as shown in FIG. 6, may be used to plan and perform the curved wellbore path (706). An image of the subterranean region of interest may be formed using the updated seismic velocity model and the observed seismic dataset, shown in FIG. 2, and the curved wellbore path (706) may be planned based, at least in part, on the image.

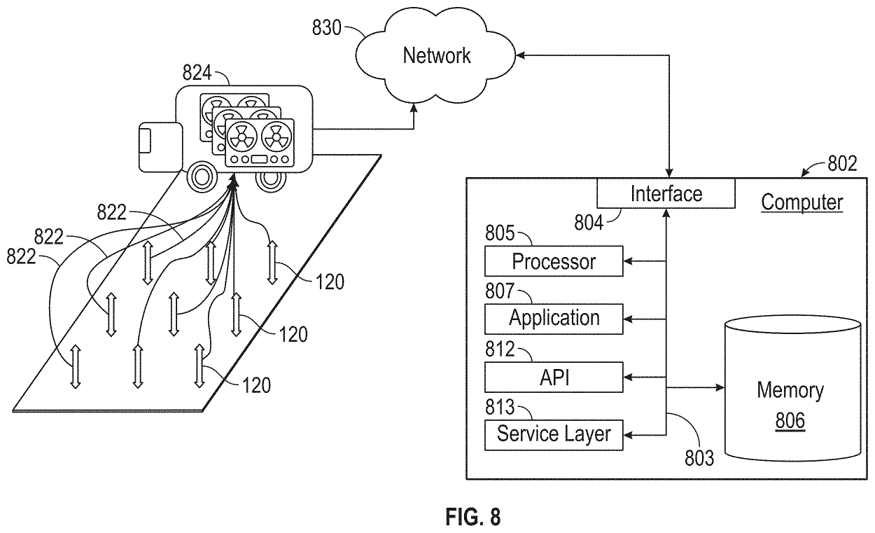

FIG. 8 shows a seismic recording and processing system, in accordance with one or more embodiments. The data recorded by a plurality of seismic receivers (120) may be transmitted to a seismic recording facility (824) located in the neighborhood of the seismic survey (100). The seismic recording facility may be one or more seismic recording trucks. The plurality of seismic receivers (120) may be in digitally or analogic telecommunication with the seismic recording facility (824). The telecommunication may be performed over telemetry channels (822) that may be electrical cables, such as coaxial cables, or may be performed wirelessly using wireless systems, such as Wi-Fi or Bluetooth. Digitization of the seismic data may be performed at each seismic receiver (120), or at the seismic recording facility (824), or at an intermediate telemetry node (not shown) between the seismic receiver (120) and the seismic recording facility (824).

The observed seismic data may be recorded at the seismic recording facility (824) and stored on non-transitory computer memory. The computer memory may be one or more computer hard-drives, or one or more computer memory tapes, or any other convenient computer memory media familiar to one skilled in the art. The seismic data may be transmitted to a computer (802) for processing. The computer (802) may be located in or near the seismic recording facility (824) or may be located at a remote location, that may be in another city, country, or continent. The seismic data may be transmitted from the seismic recording facility (824) to a computer (802) for processing. The transmission may occur over a network (830) that may be a local area network using an ethernet or Wi-Fi system, or alternatively the network (830) may be a wide area network using an internet or intranet service. Seismic data may be transmitted over a network (830) using satellite communication networks. Most commonly, because of its size, seismic data may be transmitted by physically transporting the computer memory, such as computer tapes or hard drives, in which the seismic data is stored from the seismic recording facility (802) to the location of the computer (802) to be used for processing.

FIG. 8 further depicts a block diagram of a computer system (802) used to provide computational functionalities associated with described algorithms, methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813)). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A method of identifying a drilling target, comprising:
obtaining a training set of base subsurface models;
generating, using a first artificial intelligence neural network, a plurality of subsurface model realizations based, at least in part on the base subsurface models;
simulating, for each subsurface model realization, a synthetic seismic dataset;
training a second artificial intelligence neural network, using the plurality of subsurface model realizations and the synthetic seismic dataset for each subsurface model realization, to predict an inferred subsurface model from a seismic dataset;
obtaining an observed seismic dataset for a subterranean region of interest;
predicting, using the trained second artificial intelligence neural network, an inferred subsurface model from the observed seismic dataset; and
identifying the drilling target based, at least in part, on the inferred subsurface model.

2. The method of claim 1, further comprising:
determining a wellbore path to intersect the drilling target; and
drilling a wellbore guided by the wellbore path.

3. The method of claim 1, wherein the base subsurface model comprises:
a base background model; and
a plurality of base canonical geological structures.

4. The method of claim 3, wherein a canonical geological structure may be chosen from an archaic sand dune, a wadi, and a karst.

5. The method of claim 1, wherein the first artificial intelligence network comprises a Generative Adversarial Neural Network.

6. The method of claim 1, wherein the second artificial intelligence network comprises a Deep Neural Network.

7. The method of claim 1, wherein the simulation of a synthetic seismic dataset is performed using a finite-difference solution to an elastic wave equation.

8. A non-transitory computer readable medium storing instructions executable by a computer processor, the instructions comprising functionality for:
receiving a training set of base subsurface models;
generating, using a first artificial intelligence network, a plurality of subsurface model realizations based, at least in part on the base subsurface models;
simulating, for each subsurface model realization, a synthetic seismic dataset;
training, using the plurality of subsurface model realizations and the synthetic seismic dataset for each subsurface model realization, a second artificial intelligence network to predict an inferred subsurface model from a seismic dataset;
receiving an observed seismic dataset for a subterranean region of interest;
predicting, using the trained second artificial intelligence seismic dataset, an inferred subsurface model from the observed seismic dataset; and
identifying a drilling target based, at least in part, on the inferred subsurface model.

9. The non-transitory computer readable medium of claim 8, the instructions further comprising functionality for:
determining a wellbore path to intersect the drilling target.

10. The non-transitory computer readable medium of claim 8, wherein the training set base subsurface models comprises a plurality of base canonical subsurface structures.

11. The non-transitory computer readable medium of claim 10, wherein a canonical geological structure may be chosen from an archaic sand dune, a wadi, and a karst.

12. The non-transitory computer readable medium of claim 8, wherein the first artificial intelligence network comprises a Generative Adversarial Neural Network.

13. The non-transitory computer readable medium of claim 8, wherein the second artificial intelligence network comprises a Deep Neural Network.

14. The non-transitory computer readable medium of claim 8, wherein the simulation of a synthetic seismic dataset is performed using a finite-difference solution to an elastic wave equation.

15. A system, comprising:
a memory; and
a computer processor configured to:
receive a training set of base subsurface models, the training set being stored in the memory;
generate, using a first artificial intelligence network, a plurality of subsurface model realizations based, at least in part on the base subsurface models;
simulate, for each subsurface model realization, a synthetic seismic dataset;
train, using the plurality of subsurface model realizations and the synthetic seismic dataset for each subsurface model realization, a second artificial intelligence network to predict an inferred subsurface model from a seismic dataset;
receive an observed seismic dataset for a subterranean region of interest,
predict, using the trained second artificial intelligence seismic dataset, an inferred subsurface model from the observed seismic dataset;
identify a drilling target based, at least in part, on the inferred subsurface model; and
determine a wellbore path to intersect the drilling target.

16. The system of claim 15, further comprising a drilling system to drill the wellbore guided by the wellbore path.

17. The system of claim 15, wherein the base subsurface models each comprises:
a base background model; and
a plurality of base canonical subsurface structures.

18. The system of claim 16, wherein a canonical geological structure may be chosen from archaic sand dune, a wadi, and a karst.

19. The system of claim 15, wherein:
the first artificial intelligence network comprises a Generative Adversarial Neural Network (GANN); and
the second artificial intelligence network comprises a Deep Neural Network (DNN).

20. The system of claim 15, wherein the simulation of a synthetic seismic dataset is performed using a finite-difference solution to an elastic wave equation.
